(19) United States
(12) Patent Application Publication
(10) Pub. No.: US 2007/0183816 A1
(43) Pub. Date: Aug. 9, 2007

(54) TRANSFER DEVICE AND IMAGE FORMING APPARATUS INCLUDING THE SAME

(76) Inventors: Kohji Hatayama, Osaka (JP); Tomofumi Inoue, Osaka (JP); Takeshi Sakashita, Osaka (JP); Yuuji Meguro, Takarazuka-shi (JP); Takeru Muramatsu, Osaka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/668,819

(22) Filed: Jan. 30, 2007

(30) Foreign Application Priority Data
Jan. 30, 2006 (JP) 2006-020988

(51) Int. Cl. G03G 15/01; G03G 15/20; G03G 15/16

(52) U.S. Cl. 399/299; 399/302; 399/313

(57) ABSTRACT

A transfer device including an intermediate transfer belt provided to extend in an arranged direction of a plurality of photosensitive drums, and primary transfer rollers each transferring a toner image formed on a corresponding one of the plurality of photosensitive drums to the intermediate transfer belt, each of the primary transfer rollers being moved between a position causing the intermediate transfer belt to be in contact with the photosensitive drums and a position causing the intermediate transfer belt to be separated from the photosensitive drums, each of the primary transfer rollers being rotatably supported by a movable member which includes an abutting portion which regulates a position of the primary transfer roller, the abutting portion abutting on an abutted member whose positional relationship with the photosensitive drum is defined such that the position of the abutted member causes the intermediate transfer belt to be in contact with the photosensitive drum.

### CROSS-REFERENCE TO THE RELATED APPLICATION

This application is based on and claims the priority benefit of Japanese Patent Application No. 2006-020988 filed on Jan. 30, 2006, the disclosure of which is incorporated herein by reference in its entirety.

### BACKGROUND OF THE INVENTION

1. Field of the Invention

The present invention relates to improvements in a transfer device including an intermediate transfer belt provided to extend in an arrangement direction of a plurality of photosensitive drums, and primary transfer rollers each transferring a toner image formed on a corresponding one of the photosensitive drums onto the intermediate transfer belt and an image forming apparatus including the transfer device.

2. Description of Related Art

Conventionally known is an image forming apparatus which has a structure including a transfer device provided with an intermediate transfer belt being driven in a state suspended in an arrangement direction of a plurality of photosensitive drums, and primary transfer rollers each transferring a toner image formed on a corresponding one of the photosensitive drums onto the intermediate transfer belt.

Each of the primary transfer rollers is moved away from and closer to the intermediate transfer belt between a position causing the intermediate transfer belt to be in contact with the photosensitive drums, and a position causing the intermediate transfer belt to be separated from the photosensitive drums (for reference, see Japanese Patent Application Publication No. 2003-186313).

Moreover, among the transfer devices, there is the one in which the center distance between the center axes of the photosensitive drum and the primary transfer roller at the position causing the intermediate transfer belt to be in contact with the photosensitive drums is set to be larger than the sum of the radiuses of the photosensitive drum of the primary transfer roller. The transfer device of this type is so-called an offset type transfer device.

In the meantime, a transfer device of this offset type has a configuration in which the position of the primary transfer rollers is changed between the position causing the intermediate transfer belt to be in contact with the photosensitive drums and the position causing the intermediate transfer belt to be separated from the photosensitive drums. Thus, a non-contacting distance of the intermediate transfer belt varies every time the position of the intermediate transfer belt is changed. Here, the non-contacting distance denotes a distance between a contacting portion at which the intermediate transfer belt is in contact with each of the photosensitive drums, and a contacting portion at which the intermediate transfer belt is in contact with a corresponding one of the primary transfer roller.

As a result, there is a problem that the power distribution resistance from the photosensitive drum to the primary transfer roller changes, and toner transfer efficiency varies.

### SUMMARY OF THE INVENTION

An object of the present invention is to provide a transfer device which is capable of suppressing the variation in a non-contacting distance of an intermediate transfer belt, the variation occurring due to the reciprocating positional change of a primary transfer roller, and of suppressing the variation in toner transfer efficiency, and also to provide an image forming apparatus having a compact structure by use of the transfer device.

To accomplish the aforementioned object, a transfer device according to one embodiment of the present invention includes an intermediate transfer belt provided to extend in an arranged direction of a plurality of photosensitive drums, and primary transfer rollers each transferring a toner image formed on a corresponding one of the plurality of photosensitive drums to the intermediate transfer belt.

Each of the primary transfer rollers is moved between a position causing the intermediate transfer belt to be in contact with the photosensitive drums and a position causing the intermediate transfer belt to be separated from the photosensitive drums.

A center distance between a center axis of each of the photosensitive drums and a center axis of a corresponding one of the primary transfer rollers at the position causing the intermediate transfer belt to be in contact with the photosensitive drum is set to be larger than a sum of radiuses of the photosensitive drum and the primary transfer roller, the transfer device, and each of the primary transfer rollers being rotatably supported by a movable member.

The movable member includes an abutting portion which regulates a position of the primary transfer roller. The abutting portion abuts on an abutted member whose positional relationship with the photosensitive drum is defined such that the position of the abutted member causes the intermediate transfer belt to be in contact with the photosensitive drum.

The abutted member includes an abutted surface on which the abutting portion is abutted and which is configured to regulate at least one of positional deviations of the primary transfer rollers, the one positional deviation being a positional deviation in a direction perpendicular to a direction where the intermediate transfer belt is suspended.

### BRIEF DESCRIPTION OF THE DRAWINGS

FIG. 1 is a diagram showing an overview of an image forming apparatus including a transfer device according the present invention.

FIG. 2 is an explanatory diagram which shows the part of an intermediate transfer belt of the transfer device according to the present invention in an enlarged manner, and especially which shows a state where the intermediate transfer belt is in contact with photosensitive drums.

FIG. 3 is another explanatory diagram which shows the part of the intermediate transfer belt of the transfer device according to the present invention in an enlarged manner, and especially which shows a state where the intermediate transfer belt is separated from the photosensitive drums except the photosensitive drum for a black color.

FIG. 4 is an explanatory diagram schematically showing relationships among primary transfer rollers, the photosensitive drums, and the intermediate transfer belt, according to the present invention.

FIG. 5 is a partially enlarged diagram showing relationships among the primary transfer roller, an abutting portion, the photosensitive drum and an abutted surface, according to the present invention.

FIG. 6 is a partially enlarged diagram for explaining effects of the present invention.

FIG. 7 is an explanatory diagram showing a modified example of the present invention, and especially showing a state where the abutted surface is formed at the bottom portion of a bearing member.

FIG. 8 is an explanatory diagram showing another modified example of the present invention, and especially showing a state in which primary transfer rollers are vertically driven in up and down directions.

### DESCRIPTION OF THE PREFERRED EMBODIMENT

Hereinafter, preferred embodiments of the present invention will be explained in detail with reference to the accompanying drawings.

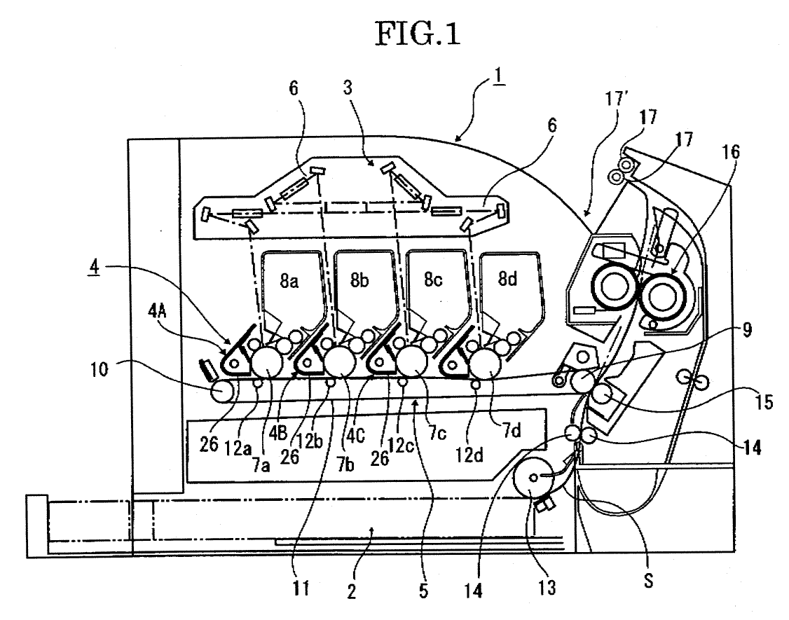

FIG. 1 is an explanatory diagram showing an overview of the image forming apparatus including the transfer device according to the present invention. In FIG. 1, reference numeral 1 denotes a main body of the image forming apparatus of a tandem system. A paper feed tray 2 is provided at a bottom part of this main body of the image forming apparatus 1, and a light exposure device 3 is provided at an upper part of the main body of the image forming apparatus 1.

Photosensitive drum cases 4 are provided between the paper feed tray 2 and the light exposure device 3. A unit type transfer device 5 is provided below the photosensitive drum cases 4.

A stack of transfer sheets is set on the paper feed tray 2. The light exposure device 3 is provided with a light exposure optical system 6 which distributes illuminated light to each of the photosensitive drums. Descriptions of the light exposure optical system 6 will be provided later. It should be noted that a light source of the light exposure is omitted in FIG. 1.

Cylindrically-shaped photosensitive drums 7a to 7d are arranged in the photosensitive drum cases 4, respectively, in the order named at predetermined intervals of a predetermined distance. Here, the photosensitive drums 7a, 7b, 7c and 7d are for yellow, cyan, magenta and black, respectively. Process cartridges 8a to 8d of yellow, cyan, magenta and black colors are installed on the respective photosensitive drum cases 4, corresponding to the photosensitive drums 7a to 7d.

An electrostatic latent image is formed on each of the photosensitive drums 7a to 7d with the light exposed by the light exposure device 3. Then, a toner is provided from each of the process cartridges 8a to 8d, and then attached to each of the photosensitive drums 7a to 7d. Accordingly, a toner image (visual image) is formed on each of the photosensitive drums 7a to 7d.

A drive roller 9 and a tension roller 10 are provided to the transfer device 5 with an interval in the arrangement direction of the photosensitive drums 7a to 7d. An intermediate transfer belt 11 is provided so as to lie across on the drive roller 9 and the tension roller 10. The intermediate transfer belt 11 is rotated while being tightly suspended in the arrangement direction of the photosensitive drums 7a to 7d. Primary transfer rollers 12a to 12d are provided to the transfer device 5, corresponding to the respective photosensitive drums 7a to 7d. The primary transfer rollers 12a to 12d are in contract with the intermediate transfer belt 11. Descriptions of the configuration and the operations of these primary transfer rollers 12a to 12d will be provided later.

A paper feed roller 13 is provided at a lower part of the main body of the image forming apparatus 1 so as to face the paper feed tray 2. A transfer sheet S is pulled out from the paper feed tray 2 by the paper roller 13.

A pair of register rollers 14 are provided to the main body of the image forming apparatus 1 at a forward position in the direction of feeding the transfer sheet S. A secondary transfer roller 15 is provided at a forward position in the direction in which the transfer sheet S is fed by the pair of register rollers 14. The secondary transfer roller 15 faces the intermediate transfer belt 11 with the transfer sheet S sandwiched therebetween,

An electrical potential difference is applied to the nip of each of the primary transfer rollers 12a to 12d and a corresponding one of the photosensitive drums 7a to 7d, and then a toner image formed on each of the photosensitive drums 7a to 7d is transferred onto the intermediate transfer belt 11 by the electrical potential difference and a pressurizing force applied by use of each of the primary transfer rollers 12a to 12d. The pair of register rollers 14 adjusts the front edge of the transfer sheet S and the front edge of the toner image to coincide with each other at the position of the secondary transfer roller 15.

Next, the toner image transferred onto the intermediate transfer belt 11 is transferred onto the transfer sheet S by using the secondary transfer roller 15.

A fixing device 16 is provided to the main body of the image forming apparatus 1 at a further forward position of the direction of feeding the transfer sheet S, onto which the toner image has been transferred. The toner attached onto the transfer sheet S is pressurized and fused, so that the toner image is fixed on the transfer sheet S as an image.

Subsequently, the transfer sheet S is delivered from the lower part of the main body of the image forming apparatus 1 to the upper part thereof by the paper feed roller 13, the pair of register rollers 14, the drive roller 9, the secondary transfer roller 15 and the fixing device 16. Then, the transfer sheet S is ejected to an ejection portion 17′ of an upper part of the main body of the image forming apparatus 1 by a pair of ejection rollers 17.

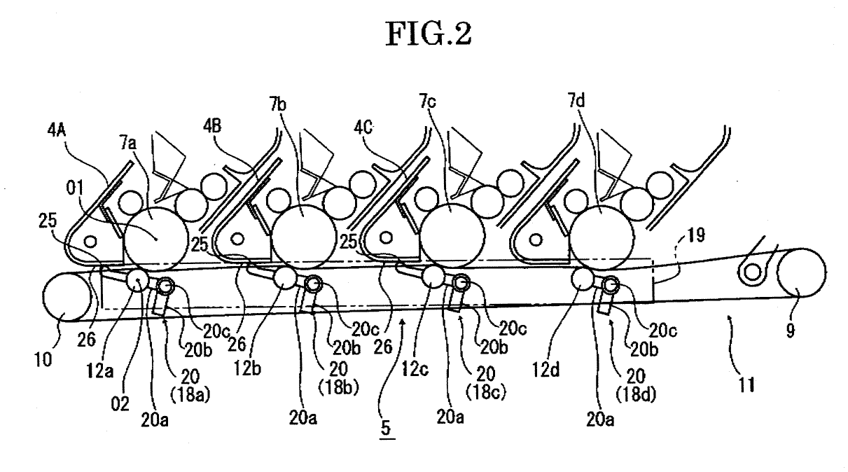

Movable members 18a to 18d are provided to the transfer device 5, corresponding to the respective photosensitive drums 7a to 7d as shown in an enlarged manner in FIG. 2. The movable members 18a to 18d are swingably supported by a fixing plate 19. Here, each of the movable members 18a to 18d is configured of a movable arm member 20. The movable arm member 20 is mainly configured of a support arm 20a and a drive arm 20b. The movable arm member 20 is rotatable around a rotation shaft 20c. The primary transfer rollers 12a to 12d are rotatably provided to the support arms 20a, respectively.

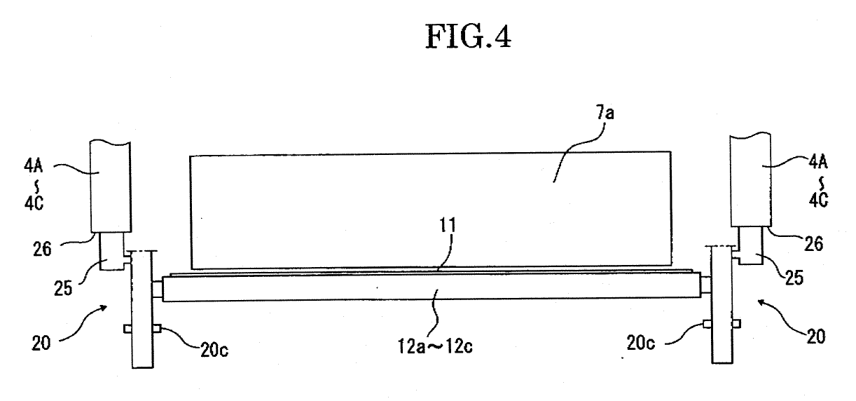

The movable arm members 20 are provided as a pair with a distance interposed therebetween in the axial direction of the photosensitive drums 7a to 7d (the width direction of the intermediate transfer belt 11) as shown in FIG. 4. Each of the primary transfer rollers 12a to 12d is suspended on the pair of the movable members 20 as shown in FIG. 4.

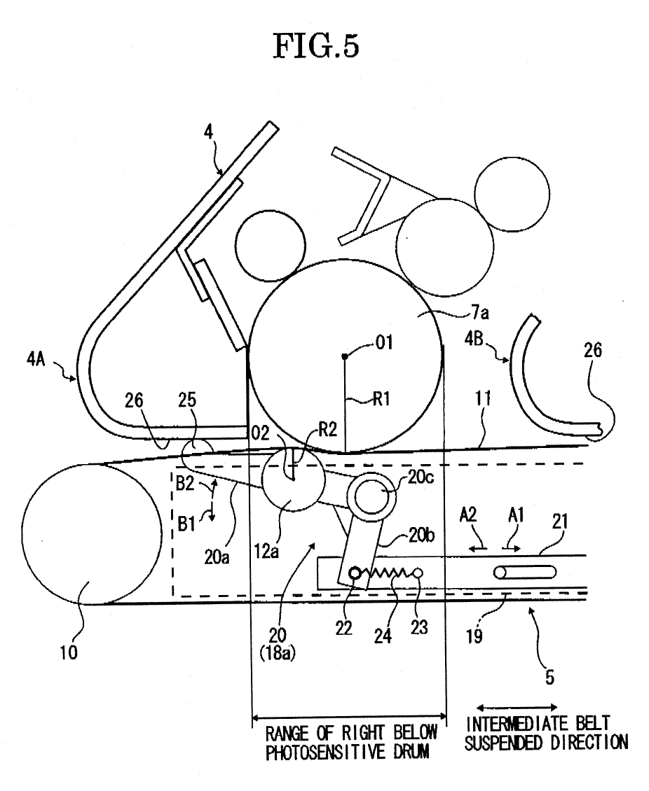

Here, the movable arm members 20 (18a to 18c) respectively for yellow, cyan and magenta colors are driven to rotate by a slide plate 21 as shown in FIG. 5, for example. FIG. 5 shows, as representatives, the photosensitive drum 7a and the pair of movable members 18a which corresponds to the photosensitive drum 7a in a partially enlarged manner.

The slide plate 21 is movable in a reciprocating manner in the directions in which the intermediate transfer belt 11 is tightly suspended (hereinafter, the directions are simply referred to as “the intermediate transfer belt 11 suspended directions”). A locking pin 22 is provided to each of the drive arms 20b of the movable arm members 20 (18a to 18c). Locking pins 23 each corresponding to each of the locking pins 22 are provided to the slide plate 21. A biasing spring 24 is provided between each of the locking pins 22 and a corresponding one of the locking pins 23.

The primary transfer rollers 12a to 12c for the colors are configured to move between a position causing the intermediate transfer belt 11 to be in contact with the photosensitive drums 7a to 7c, and a position causing the intermediate transfer belt 11 to be separated from the photosensitive drums 7a to 7c.

Here, the transfer device 5 is assumed to be so-called an offset type transfer device. To be more precise, at the position causing the photosensitive drums 7a to 7d to be in contact with the intermediate transfer belt 11, the center distance between the center axis 01 of each of the photosensitive drums 7a to 7d, and of the center axis 02 of a corresponding one of the primary transfer rollers 12a to 12d is set to be larger than a sum of a radius R1 of each of the photosensitive drums 7a to 7d and a radius R2 of each of the primary transfer rollers 12a to 12c.

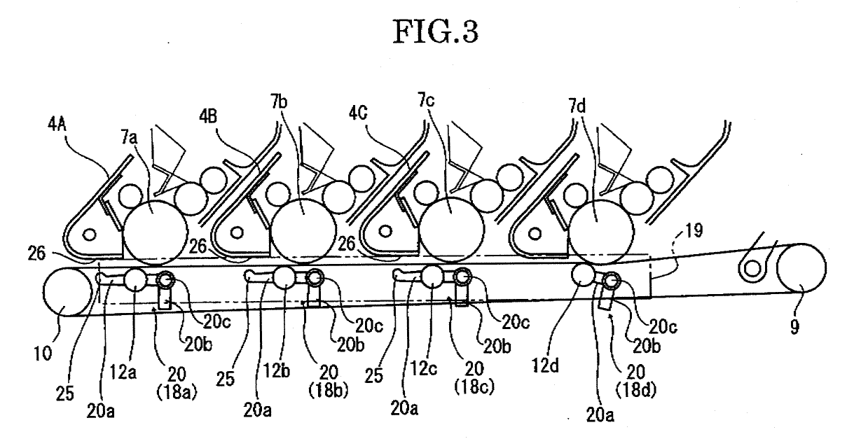

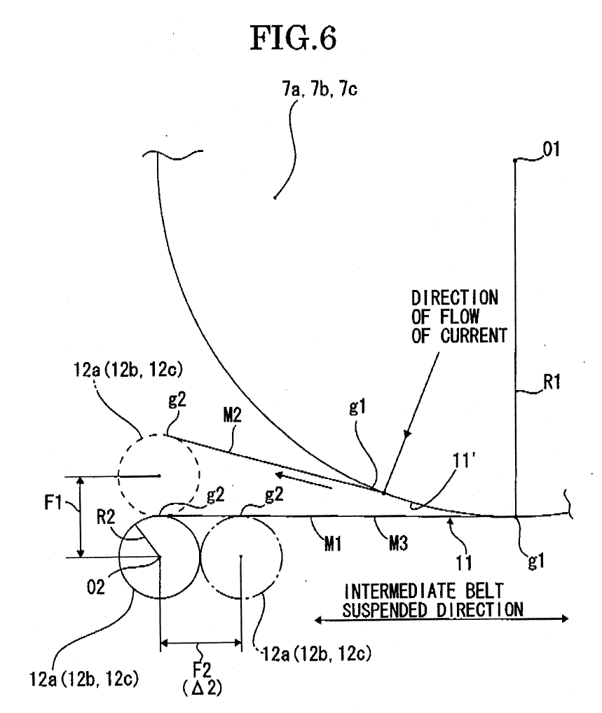

When the slide plate 21 is moved against the biasing force of a bias spring 24 in the direction of an arrow A1 as shown in FIG. 6, the movable arm members 20 (18a to 18c) for yellow, cyan and magenta colors are rotated in the direction of an arrow B1 about the rotation axes 20c. Thereby, the primary transfer rollers 12a to 12c are also moved in an arc from the position causing the intermediate transfer belt 11 to be in contact with the photosensitive drums 7a to 7d as shown in FIG. 2 to the position causing the intermediate transfer belt 11 to be separated from the photosensitive drums 7a to 7d. On the other hand, when the slide plate 21 is moved in the direction of an arrow A2 as shown in FIG. 5, the movable arm members 20 (18a to 18c) for yellow, cyan and magenta colors are rotated in the direction of an arrow B2 about the rotation axis 20c by the biasing force of the bias spring 24. Accordingly, the primary transfer rollers 12a to 12c are moved in an arc from the position causing the intermediate transfer belt 11 to be separated from the photosensitive drums 7a to 7c as shown in FIG. 3 to the position causing the intermediate transfer belt 11 to be in contact with the photosensitive drums 7a to 7c as shown in FIG. 2.

An abutting portion 25 is provided to each of the support arms 20a of the movable arm members 20 (18a to 18c) for yellow, cyan and magenta colors. Each of the abutting portions 25 regulates the position of a corresponding one of the primary transfer rollers 12a to 12c

Here, the lower portions of the photosensitive drum cases 4 function as abutted members 4A to 4C on each of which the abutting portion 25 abuts. The positional relationships between the abutted members 4A to 4C and the photosensitive drums 7a to 7c are defined such that the positions of the abutted members causes the intermediate transfer belt 11 to be in contact with the photosensitive drums 7a to 7c. Each of the abutted members 4A to 4C includes an abutted surface 26 on which the abutting portion 25 abuts at the position causing the intermediate transfer belt 11 to be in contact with the photosensitive drums 7a to 7c.

The abutted surface 26 is formed of a flat surface parallel with the intermediate transfer belt 1 suspended directions. The abutting portion 25 has a circular arc shape as shown in an enlarged manner in FIG. 5. Each of the primary transfer rollers 12a to 12c is located between the abutting portion 25 and the rotation axis 20c. Then, at the position where the primary transfer rollers 12a to 12c cause the intermediate transfer belt 11 to be in contact with the photosensitive drums 7a to 7c, the abutting portions 25 are positioned to protrude upwardly from the intermediate transfer belt 11 being in contact with the photosensitive drums 7a to 7c.

Each of the abutted members 4A to 4C has a role to regulate one of positional errors of a corresponding one of the primary transfer rollers 12a to 12c. Specifically, the abutted members 4A to 4C regulate the positional error in the direction in which the abutting portion 25 abuts on the abutted surface 26, and which is perpendicular to the intermediate transfer belt 11 suspended directions.

It should be noted that, here, the primary transfer roller 12d is rotatably held at a position where the primary transfer roller 12d is in contact with the photosensitive drum 7d while sandwiching the intermediate transfer belt 11 therebetween. The primary transfer roller 12d is used at the time of a monochrome printing operation performed by use of only a black color.

Employing such a configuration suppresses the variation in a non-contacting distance of the intermediate transfer belt 11 due to the reciprocating positional change of each of the primary transfer rollers 12a to 12c. As a consequence, the variation in toner transfer efficiency can be suppressed.

FIG. 6 is a schematic diagram for explaining the variation in a non-contacting distance of the intermediate transfer belt 11 due to the reciprocating positional change of each of the primary transfer rollers 12a to 12c.

Specifically, as shown in FIG. 6, consider a case where the position of each of the primary transfer rollers 12a to 12c varies in the up and down directions (the directions are perpendicular to the intermediate transfer belt 11 suspended directions) within a range F1 due to the reciprocating positional change of each of the primary transfer rollers 12a to 12c. In this case, the non-contacting distance of the intermediate transfer belt 11 varies within a variation range from M1 to M2. Here, the non-contacting distance of the intermediate transfer belt 11 denotes the distance between a contacting portion g1 and a contacting portion g2 of the intermediate transfer belt 11. At the contacting portion g1, the intermediate transfer belt 11 is in contact with each of the photosensitive drums 7a to 7c, and at the contacting portion g2, the intermediate transfer belt 11 is in contact with each of the primary transfer rollers 12a to 12c.

On the other hand, consider a case where the position of each of the primary transfer rollers 12a to 12c varies in the right and left directions (the intermediate transfer belt 11 suspended direction) within a range F2 due to the reciprocating positional change of each of the primary transfer rollers 12a to 12c. In this case, the non-contacting distance of the intermediate transfer belt 11 varies within a variation range from M1 to M3. Here, similarly, the non-contacting distance of the intermediate transfer belt 11 denotes the distance between the contacting portion g1 at which the intermediate transfer belt 11 is in contact with each of the photosensitive drums 7a to 7c, and the contacting portion g2 at which the intermediate transfer belt 11 is in contact with each of the primary transfer rollers 12a to 12c.

In FIG. 6, the primary transfer roller 12a (12b and 12c) indicated by a solid line shows the reference position of the variation ranges F1 and F2. The primary transfer roller 12a (12b and 12c) indicated by a broken line shows the state being at the upper limit position of the variation range F1 and also at the reference position of the variation range F2. The primary transfer roller 12a (12b and 12c) indicated by an alternate long and short dash line shows the state being at the reference position of the variation line F1 and also at the rightmost position of the variation range F2.

Furthermore, the non-contacting distance M1 means the length of a non-contacting portion between the contacting portion g1 at which the intermediate transfer belt 11 is in contact with each of the photosensitive drums 7a to 7c, and the contacting portion g2 at which the intermediate transfer belt 11 is in contact with each of the primary transfer rollers 12a to 12c, when each of the primary transfer rollers 12a to 12c are at the reference position. The non-contacting distance M2 means the length of a non-contacting portion between the contacting portion g1 at which the intermediate transfer belt 11 is in contact with each of the photosensitive drums 7a to 7c, and the contacting portion g2 at which the intermediate transfer belt 11 is in contact with each of the primary transfer rollers 12a to 12c, when each of the primary transfer rollers 12a to 12c is at the uppermost position of the variation range F1 and also at the reference position of the variation range F2. The non-contacting distance M3 means the length of a non-contacting distance between the contacting portion g1 at which the intermediate transfer belt 11 is in contact with each of the photosensitive drums 7a to 7c, and the contacting portion g2 at which the intermediate transfer belt 11 is in contact with each of the primary transfer rollers 12a to 12c, when each of the primary transfer rollers 12a to 12c is at the reference position of the variation range F1 and also at the rightmost position of the variation range F2.

The variation Δ1 (Δ1=M1−M2) in the up and down directions of the non-contacting distance of the intermediate transfer belt 11 is greater than the variation Δ2 (Δ2=M3−M1) in the right and left directions of the contacting distance of the intermediate transfer belt 11. This is because, as shown in FIG. 6, when the positional errors of the primary transfer rollers 12a to 12c occur in the up and down directions, the intermediate transfer belt 11 is wound around the outer circumferential surfaces of the photosensitive drums 7a to 7c. Reference numeral 11′ is given to the wound portion of the intermediate transfer belt 11.

A predetermined electrical potential is previously applied to each of the photosensitive drums 7a to 7c, and a toner is attached thereto in accordance with exposure light. Then, an electrical potential difference V occurs between each of the photosensitive drums 7a to 7c and a corresponding one of the primary transfer rollers 12a to 12c. Here, when there is a change in the length of the non-contacting portion between the contacting portion g1 at which the intermediate transfer belt 11 is in contact with the photosensitive drums 7a to 7c, and the contacting portion g2 at which the intermediate transfer belt 11 is in contact with the primary transfer rollers 12a to 12c, the amount of resistance corresponding to the length of the intermediate transfer belt 11 varies in accordance with the length of the non-contacting portion. This causes the electrical potential difference V to vary, thereby resulting in a change in transfer efficiency to the intermediate transfer belt 11.

In this situation, the variation in the non-contacting distance of the intermediate transfer belt 11 can be suppressed by regulating the positional error of each of the primary transfer rollers 12a to 12c in the up and down directions (the directions perpendicular to the intermediate transfer belt 11 suspended directions), the positional error occurring due to the reciprocating positional change of each of the primary transfer rollers 12a to 12c.

### MODIFIED EXAMPLE 1

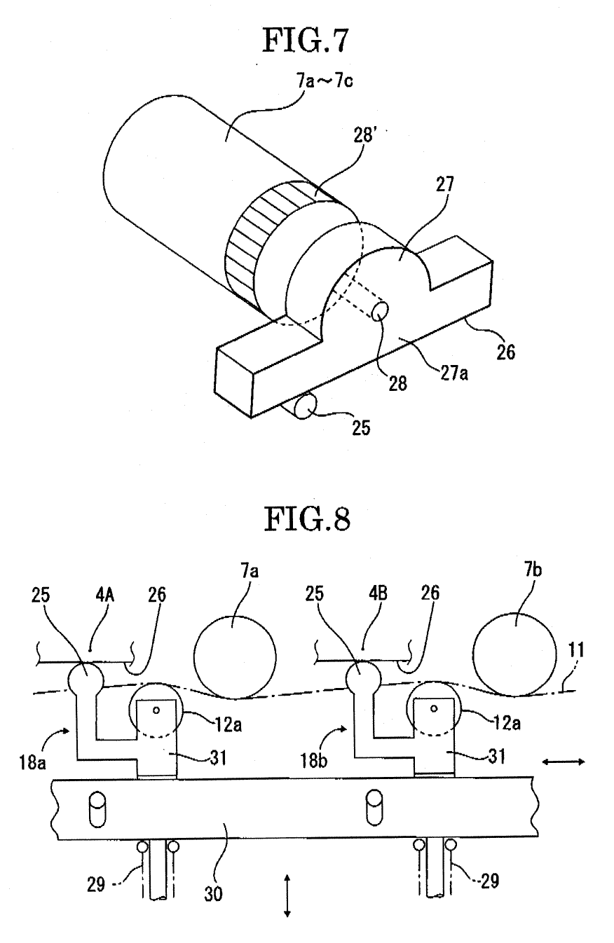

Although the lower portions of the photosensitive drum cases 4 are employed as the abutted members 4A to 4C in the foregoing embodiment, lower portions 27a of shaft bearing members 27 of the photosensitive drums 7a to 7c may be used as shown in FIG. 7. It should be noted that, in FIG. 7, reference numeral 28 denotes a center shaft of each of the photosensitive drums 7a to 7c, and a reference numeral 28′ denotes a gear. Here, each of the photosensitive drums 7a to 7c rotates around the center shaft 28.

### MODIFIED EXAMPLE 2

Here, as shown in FIG. 8, the movable members 18a to 18c is provided with an up and down directional plate 30 biased upwardly by springs 29. Shaft bearing plates 31 integrally including the respective abutting portions 25 are provided to the up and down directional plate 80. The primary transfer rollers 12a to 12c are rotatably supported by the shaft bearing plates 31, respectively.

In Modified Example 2, the position causing the intermediate transfer belt 11 to be in contact with the photosensitive drums 7a to 7c, and the position causing the intermediate transfer belt 11 to be separated from the photosensitive drums 7a to 7c exist in a direction perpendicular (vertical direction) to the intermediate transfer belt 11 suspended directions. Accordingly, when the up and down directional plate 30 is lowered, the position of the primary transfer rollers 12a to 12c is changed from the position causing the intermediate transfer belt 11 to be in contact with the photosensitive drums 7a to 7c, to the position causing the intermediate transfer belt 11 to be separated from the photosensitive drums 7a to 7c.

On the other hand, when the up and down directional plate 30 is moved upward, the position of the primary transfer rollers 12a to 12c is changed from the position causing the intermediate transfer belt 11 to be separated from the photosensitive drums 7a to 7c, to the position causing the intermediate transfer belt 11 to be in contact with the photosensitive drums 7a to 7c.

Although the preferred embodiments of the present invention have been mentioned, it should be noted that the present invention is not limited to these embodiments, various modifications and changes can be made to these embodiments.

What is claimed is:

1. A transfer device, comprising:
an intermediate transfer belt provided to extend in an arranged direction of a plurality of photosensitive drums; and
primary transfer rollers each transferring a toner image formed on a corresponding one of the plurality of photosensitive drums to the intermediate transfer belt,
each of the primary transfer rollers being moved between a position causing the intermediate transfer belt to be in contact with the photosensitive drums and a position causing the intermediate transfer belt to be separated from the photosensitive drums,
a center distance between a center axis of each of the photosensitive drums and a center axis of a corresponding one of the primary transfer rollers at the position causing the intermediate transfer belt to be in contact with the photosensitive drum being set to be larger than a sum of radiuses of the photosensitive drum and the primary transfer roller, the transfer device, and each of the primary transfer rollers being rotatably supported by a movable member,
wherein the movable member includes an abutting portion which regulates a position of the primary transfer roller,
wherein the abutting portion abuts on an abutted member whose positional relationship with the photosensitive drum is defined such that the position of the abutted member causes the intermediate transfer belt to be in contact with the photosensitive drum, and
wherein the abutted member includes an abutted surface on which the abutting portion is abutted and which is configured to regulate at least one of positional deviations of the primary transfer rollers, the one positional deviation being a positional deviation in a direction perpendicular to a direction where the intermediate transfer belt is suspended.

2. The transfer device according to claim 1, wherein the abutted surface is a flat surface parallel with the intermediate transfer belt suspended direction.

3. The transfer device according to claim 2, wherein the abutted member is formed by a portion of a case which houses the photosensitive drum.

4. The transfer device according to claim 2, wherein the abutted member is formed by a portion of a shaft bearing member for the photosensitive drum.

5. The transfer device according to claim 2, wherein,
the position causing the intermediate transfer belt to be in contact with the photosensitive drum and the position causing the intermediate transfer belt to be separated from the photosensitive drum exist in a direction perpendicular to the intermediate transfer belt suspended directions, and
the movable member is configured to cause the primary transfer roller to reciprocate between both of the positions.

6. The transfer device according to claim 2, wherein the movable member is configured to cause the primary transfer roller to reciprocate in an arc between the position causing the intermediate transfer belt to be in contact with the photosensitive drum, and the position causing the intermediate transfer belt to be separated from the photosensitive drum.

7. The transfer device according to claim 5, wherein the abutting portion has a circular are shape.

8. The transfer device according to claim 6, wherein the abutting portion has a circular arc shape.

9. The transfer device according to claim 6, wherein,
the movable member comprises an arm which is rotated about a rotation shaft, and
the primary transfer roller is located between the abutting portion and the rotation shaft.

10. The transfer device according to claim 7, wherein,
the movable member comprises an arm which is rotated about a rotation shaft, and
the primary transfer roller is located between the abutting portion and the rotation shaft.

11. The transfer device according to claim 8, wherein,
the intermediate transfer belt is located below the photosensitive drums, and
the abutting portion is positioned to protrude upwardly from the intermediate transfer belt at the position where the primary transfer rollers causes the intermediate transfer belt to be in contact with the photosensitive drums.

12. An image forming apparatus comprising the transfer device as recited in claim 1.
